(19) United States
(12) Patent Application Publication
(10) Pub. No.: US 2012/0311092 A1
(43) Pub. Date: Dec. 6, 2012

(54) ECG DATA MONITOR

(75) Inventors: Torsten MUSIOL, Ratingen (DE); David William LEWIS, Atlanta, GA (US); Marcos Ulises TONG ALVAREZ, Espoo (FI); Ole REINARTZ, Neuss (DE); Remberto MARTINEZ GONZALEZ, Pinsio (FI); Vreddhi BHAT, Bangalore (IN)

(73) Assignee: NOKIA SIEMENS NETWORKS OY, Espoo (FI)

(21) Appl. No.: 13/151,392

(22) Filed: Jun. 2, 2011

(51) Int. Cl. G06F 15/16

(52) U.S. Cl. 709/219

(57) ABSTRACT

The invention provides a simple low-cost electrocardiography (ECG) monitoring device connected to a server (typically cloud based) via a mobile network with a mobile phone acting as a gateway. The time period between successive provisions of ECG data to said remote server is variable. The system enables ECG data to be collected over a long period of time in a system in which each of the elements can be optimized.

The present invention is related to the collection and use of electrocardiography (ECG) data.

Cardiovascular disease (CVD) is the number one cause of death globally. By 2030, 40.5% of the US population is projected to have some form of CVD. Between 2010 and 2030, real total direct medical costs of CVD are projected to triple, from $273 billion to $818 billion. Real indirect costs (due to lost productivity) for all CVD are estimated to increase from $172 billion in 2010 to $276 billion in 2030, an increase of 61%.

CVD incidents are usually associated with cardiac arrhythmias. On the other hand, issues related to cardiac arrhythmia risk do not only apply to persons with known cardiac disease or after a heart attack, but there are many other risk factors for cardiovascular diseases and sudden cardiac death.

The number of out-of-hospital sudden cardiac arrests (SCA) is significant. According to a study made in UK, 74% of all fatal events occurred outside hospital. Fewer than eight percent of people who suffer cardiac arrest outside the hospital survive.

In case of suspected heart issues, patients usually need to remain in hospital for ECG monitoring, or have to use an expensive home monitoring unit (event recorder).

As is well known in the art, electrocardiograph (ECG) techniques monitor the electrical activity of the heart. A typical ECG tracing of the cardiac cycle (heartbeat) consists of a P wave, a QRS complex and a T wave.

For ECG interpretation, the P, QRS and T waves are analyzed in terms of amplitude, duration, intervals between peaks and valleys and changes over time. Very often, rhythm events do not occur continuously, but require long observation time (perhaps one or more days).

A complete ECG analysis requires measurement of 12 voltages between different locations on the human body (12-lead ECG). In one embodiment of the invention, in order to meet the target of low cost and easy usability, a known single-lead ECG sensor is used. Single-lead ECG sensors detect many, but not all, heart anomalies. Clearly, any suitable ECG sensor, such as known 3-lead, 5-lead and 12-lead sensors could be used in embodiments of the present invention.

In addition to electrical measurement, acceleration measurement is performed in order to detect physical movement of the patient. This information is used to adjust thresholds for feedback notifications dynamically.

Doctor resources today are stretched with unnecessary visits from patients. It is also clear that an aging population is placing further burden on health care resources. On the other hand, there is a growing trend with consumers wanting to independently control and manage their own healthcare. No market solution is currently available to provide mobility to patients with real time feedback such as warning of critical events or issues.

The present invention seeks to address at least some of the problems outlined above.

The invention provides a mobile communication device comprising a first input configured to receive electrocardiography (ECG) data of a user of the mobile communication device and a first output configured to provide said electrocardiography data to a server (typically a remote server) via a mobile communications link, wherein said first output is configured to periodically provide said electrocardiography data to the server via the mobile communications link, wherein a time period between successive provisions of electrocardiography data to said server is variable.

A second input may be provided for receiving an indication from the server of a desired period between successive provisions of electrocardiography data to said server. For example, a doctor interacting with the server may control the rate of provision of ECG data.

A third input may be provided for receiving an indication from the user of a desired period between successive provisions of electrocardiography data to said server. An algorithm may be required for handling conflicts between a rate of provision of ECG data set by the server and set by the user. For example, one or the other may take precedence. Alternatively, the highest data rate may take precedence. In a further alternative, the most recently set rate might take precedence.

Different modes may be provided in which the data upload period differs between the modes. For example, in a first mode, the time period between successive provisions of electrocardiography data to said server may be equal to or greater than one day. In a second mode, the time period between successive provisions of electrocardiography data to said server may be less than one hour (e.g. of the order of one minute). In a third mode, the time period between successive provisions of electrocardiography data to said server may be zero (such that the data transmission is continuous).

In some forms of the invention, the time period between successive provisions of electrocardiography data is at least partially dependent on the power level of the mobile communication device.

The present invention also provides an apparatus (e.g. a server) comprising: a first input configured to receive electrocardiography data from a mobile communication device via a mobile communications link, wherein the electrocardiography data relates to a user of said mobile communication device; and a first output for indicating to the mobile communication device a desired period between successive provisions of the electrocardiography data.

A second input may be provided for indicating a desired period between successive provisions of the electrocardiography data. For example, a doctor interacting with the server may control the rate of provision of electrocardiography data.

As described above, different modes may be provided in which the data upload period differs between the modes.

The present invention further provides a system comprising a mobile communication device and a server, wherein: the mobile communication device comprises a first input configured to receive electrocardiography data of a user of the mobile communication device and a first output configured to provide said electrocardiography data to the server via a mobile communication link wherein said first output is configured to periodically provide said electrocardiography data to the server via the mobile communications link, wherein a time period between successive provisions of electrocardiography data to said server is variable; and said server comprises a first input for receiving said electrocardiography data. The server may have a processor for processing said electrocardiography data. The server may have a first output for setting a desired period between successive provisions of the electrocardiography data. The system may further comprise an ECG sensor.

The present invention yet further provides a method comprising: receiving electrocardiography (ECG) data of a user at a first input of a mobile communication device; and periodically providing said electrocardiography data from the mobile communication device to a server (typically a remote server) via a mobile communications link, wherein a time period between successive provisions of electrocardiography data to said server is variable.

The period between successive provisions of electrocardiography data may be at least partially set by the server. For example, a doctor interacting with the server may control the rate of provision of ECG data. The period between successive provisions of electrocardiography data may be at least partially set by the user. An algorithm may be required for handling conflicts between a rate of provision of ECG data set by the server and set by the user. For example, one or the other may take precedence. Alternatively, the highest data rate may take precedence. In a further alternative, the most recently set rate might take precedence. As described above, different modes may be provided in which the data upload period differs between the modes.

The present invention also provides a method comprising: receiving electrocardiography data from a mobile communication device via a mobile communication link, wherein the electrocardiography data relates to a user of said mobile communication device; and indicating to the mobile communication device a desired time period between successive provisions of electrocardiography. The method may include receiving a desired period between successive provisions of the electrocardiography data. For example, a doctor interacting with the server may control the rate of provision of ECG data.

The present invention further provides a computer program comprising: code (or some other means) for receiving electrocardiography (ECG) data of a user at a first input of a mobile communication device; and code (or some other means) for periodically providing said electrocardiography data from the mobile communication device to a server via a mobile communications link, wherein a time period between successive provisions of electrocardiography data to said server is variable. The computer program may be a computer program product comprising a computer-readable medium bearing computer program code embodied therein for use with a computer.

The present invention yet further provides a computer program comprising: code (or some other means) for receiving electrocardiography data from a mobile communication device via a mobile communication link, wherein the electrocardiography data relates to a user of said mobile communication device; and code (or some other means) for indicating to the mobile communication device a desired time period between successive provisions of electrocardiography. The computer program may be a computer program product comprising a computer-readable medium bearing computer program code embodied therein for use with a computer.

Exemplary embodiments of the invention are described below, by way of example only, with reference to the following numbered drawings.

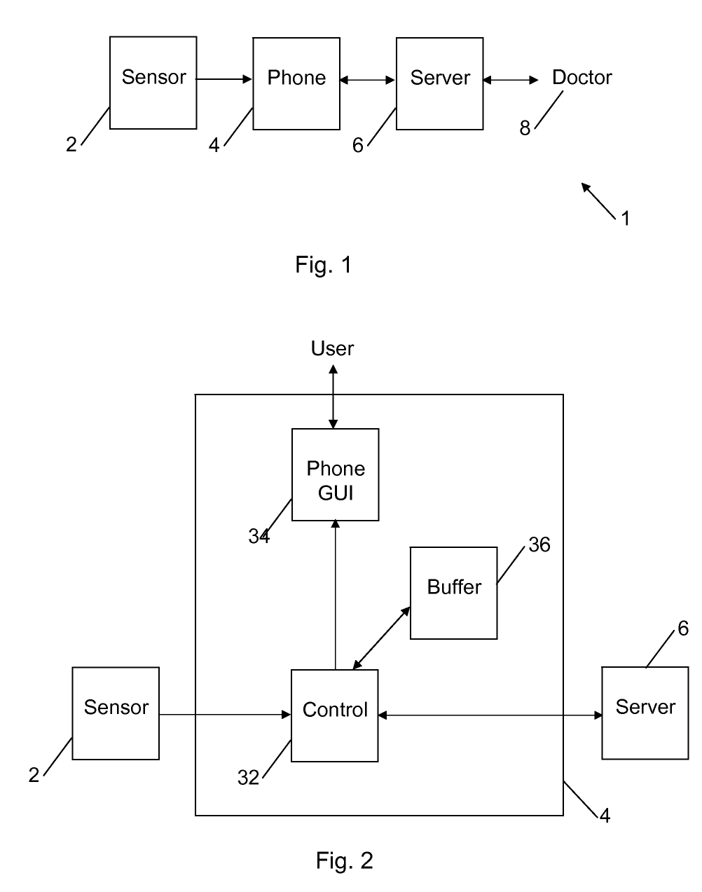

FIG. 1 is a block diagram of a system in accordance with an aspect of the present invention;

FIG. 2 is a block diagram showing further details of the system of FIG. 1;

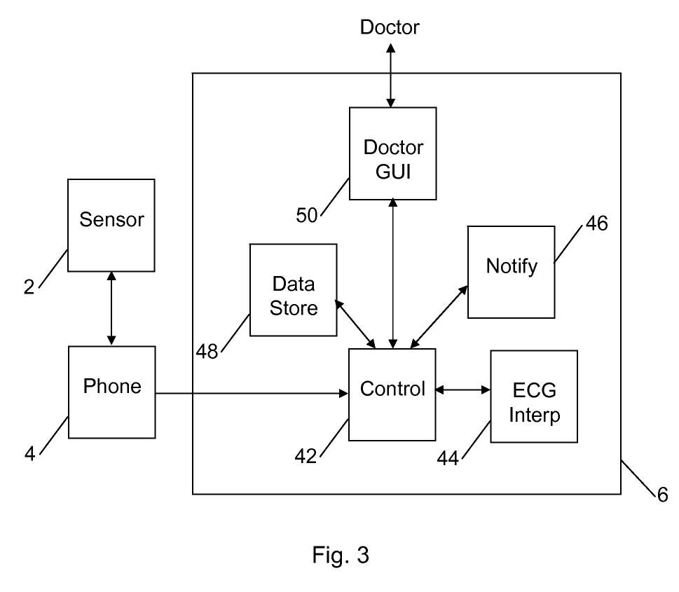

FIG. 3 is a block diagram showing further details of the system of FIG. 1; and

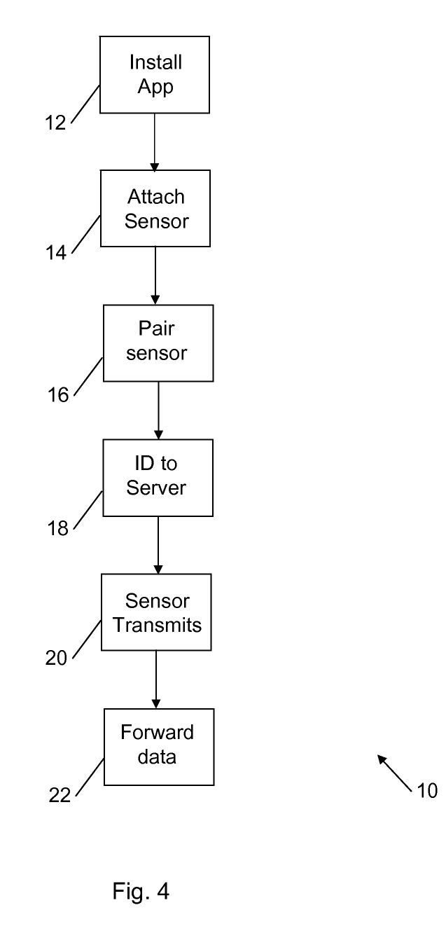

FIG. 4 is a flow chart showing an exemplary use of the system of FIG. 1;

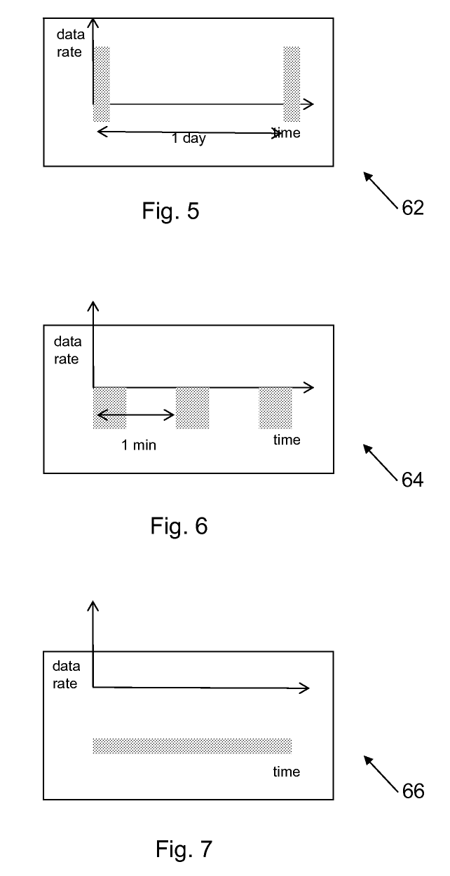

FIG. 5 shows a data upload arrangement in accordance with an aspect of the present invention;

FIG. 6 shows a data upload arrangement in accordance with a aspect of the present invention;

FIG. 7 shows a data upload arrangement in accordance with an aspect of the present invention;

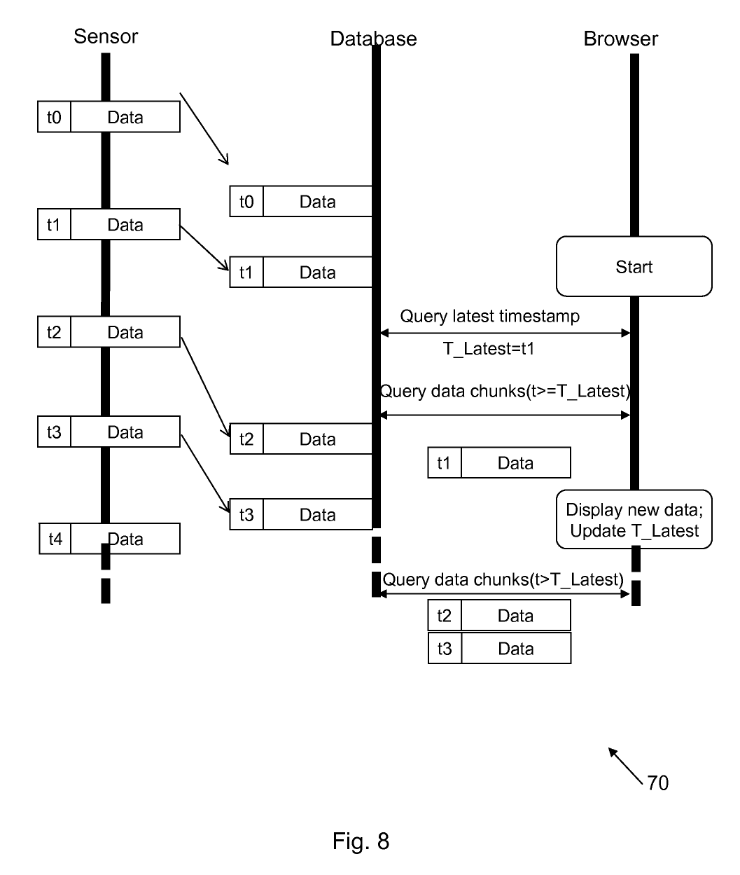

FIG. 8 is a message flow diagram in accordance with an aspect of the present invention; and

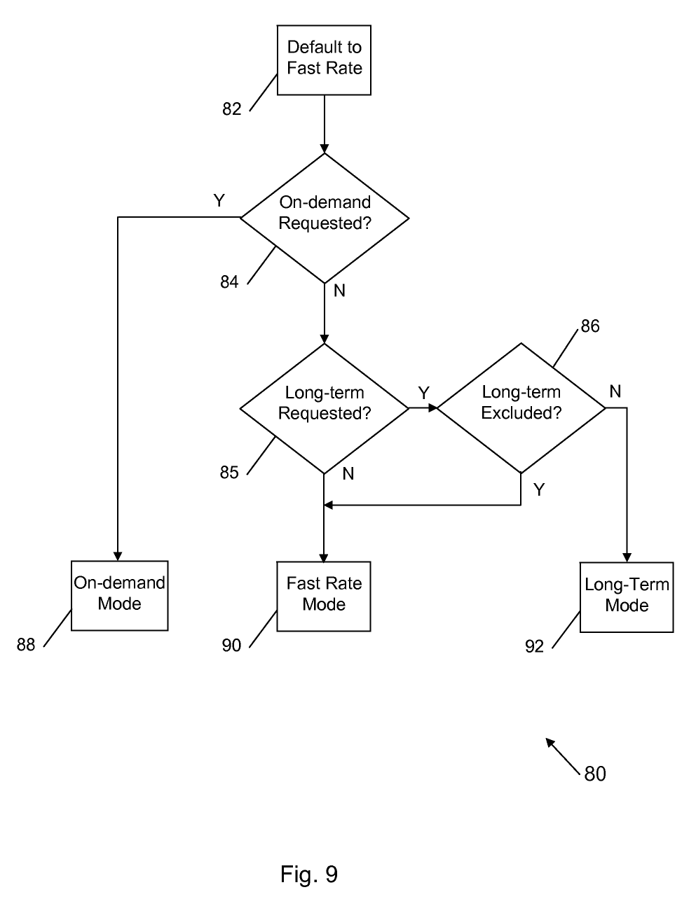

FIG. 9 is a flow chart showing an algorithm in accordance with an aspect of the present invention.

FIG. 1 is a block diagram of a system, indicated generally by the reference numeral 1, in accordance with an aspect of the present invention.

The system 1 comprises one or more sensors 2, a mobile communication device 4, and a server 6 and may additionally include a doctor 8. The sensor(s) 2 provide data to the mobile communication device 4. The device 4 is in two-way communication with the server 6 and so is able to upload data received from the sensor 2 to the server 6. The doctor 8 (when present in the system 1) is in two-way communication with the server 6 and can therefore access data uploaded to the server 6 by the mobile communication device 4.

The sensor 2 is an electrocardiography (ECG) sensor; however, the ECG sensor 2 may take many different forms. Indeed, one of the advantages of the present invention is that the system is sufficiently flexible to allow any suitable sensor to be used. Exemplary sensors 2 may, however, be chosen to meet at least some of the following criteria:
Single-lead ECG measurement
Acceleration measurement
Lead-off detection (whether the sensor is properly attached)
Battery supervision
Wireless connectivity to the mobile communication device 4
Low cost
Easy to handle by the user
Long battery lifetime (several days continuous operation)

Due to long-term usage, a sealed package is ideal.

FIG. 2 is a further block diagram showing the sensor 2, mobile communication device 4 and server 6 of the system 1 and additionally showing further details of the mobile communication device 4. As shown in FIG. 2, the mobile communication device includes a controller 32 that receives data from the sensor 2 and is in two-way communication with the server 6. The device 4 also includes a graphical user interface (GUI) 34 and a buffer 36 that are each in two-way communication with the controller 32. The GUI 34 enables the user (i.e. the subject of the monitoring by the sensor 2) to interact with the mobile communication device 4.

The device 4 typically supports at least some of the following functionality: pairing with the sensor 2; reception of ECG, impedance and acceleration measurement data from the sensor 2; display of ECG measurement data in a sliding window of the GUI 34; buffering (using the buffer 36) of measurement data with respect to the configurable data upload frequency; uploading of measurement data to the server 6; notifying the user if network connectivity is interrupted (WAN supervision), sensor connectivity is interrupted, in particular if the phone is not in proximity of the patient (PAN supervision), if the sensor device is not properly attached (lead-off detection) or if the sensor battery needs to be replaced or recharged; and notification to the user of ECG interpretation results (via the GUI 34). Many of these features are discussed further below.

FIG. 3 is a further block diagram showing the sensor 2, the mobile communication device 4 and the server 6 of the system 1 and additionally showing further details of the server 6. As shown in FIG. 3, the server 6 includes a controller 42, an ECG interpreter 44, a notification engine 46, a data store 48 and a graphical user interface (GUI) 50 for the doctor. The controller 42 is in two-way communication with the mobile communication device 4, the ECG interpreter 44, the notification engine 46, the data store 48 and the GUI 50. The doctor 8 interfaces with the server 6 via a two-way connection with the GUI 50.

In use, the mobile communication device 4 receives data from the sensor 2 and forwards that data (in a format discussed further below) to the controller 42 of the server 6. The controller 42 communicates with the data store 48 to store the data.

Data is sent from the controller 42 to the ECG interpreter 44 for analysis and results are returned to the controller 42. The results obtained from the ECG interpreter 42 are typically also stored in the data store 48. The doctor 8 uses the GUI 50 to access the data stored in the data store 48. Thus, the doctor can gain access to both the raw data received at the server 6 from the mobile communication device 2 and the results obtained from the ECG interpreter 44.

In some cases, the controller 42 may determine that a user (e.g. the subject of the monitoring by the sensor 2 of the doctor 8) should be informed of an event (such as an arrhythmia detected by the ECG interpreter 44 or a problem noted by the doctor 8). In this case, the controller 42 communicates with a notification engine 46 and the engine provides a message for sending to the user (typically to the mobile communication device 4).

At least some of the elements of the server 6 may be provided remotely from the server. For example, the ECG interpreter 44 may be provided by a third party, with the server 6 sending data to the ECG interpreter and the ECG interpreter returning results to the controller 42 of the server 6. Similarly, data storage, such as the data store 48 may be provided remotely.

The server application software correlates the measured ECG data with the acceleration data and identifies heart rhythm anomalies (arrhythmia). This function is known as ECG interpretation. The doctor 8 analyzes the data through a GUI 50.

The GUI 50 for the doctor supports the following functions: secure login (by the doctor 8); management of patient data (Patient List Page); browsing through stored and interpreted ECG data (ECG Page); filtering and grouping of arrhythmia events; and annotations to the ECG data.

FIG. 4 is a flow chart, indicated generally by the reference numeral 10, showing an exemplary use of the system 1.

The algorithm 10 starts at step 12, where the patient installs the relevant application on his mobile communication device 4. Next, at step 14, the patient attaches the sensor 2 to his chest.

The newly-attached sensor 2 needs to be paired with the mobile communication device 4 that the patient will use to upload data to the server 6. This is done in step 16 and need be done only once. Subsequently, the connection between the sensor 2 and the mobile communication device 4 is established automatically.

Next, at step 18, the patient logs into the server 6 using the application installed on his mobile communication device in step 12 above using credentials (username, password) as provided, for example, by the doctor 8.

At this stage, the sensor 2 is paired with the mobile communication device 4. Accordingly, at step 20, ECG measurement data is wirelessly transmitted from the sensor 2 to the mobile communication device 4. Next, at step 22, the data received at the mobile communication device 4 from the sensor 2 is transmitted to the server 6. Steps 20 and 22 are repeated for the duration of the measurement period.

Depending on the risk position of the patient and the actual medical need, the following sub-use cases (applications) are supported: very-long-term ECG (non-real-time); fast response (near real-time); and on demand (real-time). The different upload arrangements are shown in FIGS. 5 to 7.

FIG. 5 is a graph, indicated generally by the reference numeral 62, showing the very-long-term ECG arrangement referred to above. As shown in FIG. 5, data is uploaded once per day (although a different period could, of course, be chosen). By uploading data only once per day, the communication between the mobile communication device 4 and the server 6 is limited (thereby reducing communication costs and power usage in the mobile communication device). The very-long-term ECG arrangement also requires the buffer 36 of the mobile communication device 4 to be used to store data provided by the sensor in between uploads to the server 6.

FIG. 6 is a graph, indicated generally by the reference numeral 64, showing the fast response ECG arrangement referred to above. The fast-response ECG arrangement has a much shorter upload period compared with the very-long term ECG arrangement 62. As shown in FIG. 6, the upload period may be 1 minute, although, of course, other periods could be chosen. Continuous automatic ECG interpretation allows for fast response in case of a dangerous situation for the patient. This application requires more resources, in particular battery power from the mobile phone and a consistent network connection. During phases of network unavailability, the data will be stored at the buffer 36 of the mobile phone.

FIG. 7 is a graph, indicated generally by the reference numeral 66, showing the on-demand ECG arrangement referred to above. On-demand ECG sends data continuously from the device 4 to the server 6 and supports remote diagnosis without a visit to the doctor.

FIG. 8 shows a message flow diagram, indicated generally by the reference numeral 70, in accordance with an aspect of the present invention. The message flow diagram 70 shows data at a sensor, data at a database (received from the sensor) and data at a browser (received from the database).

Each data chunk provided by the sensor includes a timestamp (t0, t1, t2 etc.) and a data portion. As shown in FIG. 8, the data chunks are provided with a regular time interval. The data chunks are, however, received at the database with differing time intervals, due, for example, to transmission delays. These delays cause potential problems to the display at the browser.

As shown in FIG. 8, the browser, when ready to display data, requests the most recently received timestamp (t1 in the exemplary message flow 70). In response, the browser requests all data having a timestamp of t1 or later (only the data portion t1 in this example).

When the browser is ready for further data, it increments the timestamp and asks for all data with a timestamp greater than t2. In this example, however, due to differing delays, two additional data chunks (with timestamps t2 and t3) are provided and can be displayed at the browser.

Accordingly, the browser can readily handle data that arrives at the database with differing delays.

The fast response ECG arrangement provides regular data but is less expensive in terms of communications costs and power consumption in the mobile communication device 4 than the on-demand arrangement. The fast response ECG arrangement may, for example, be used for patients that are considered at risk of heart problems where near real-time monitoring is desired. The monitoring mode may, for example, be modifiable so that in the event of a potential anomaly being detected in the data received from the patient, the upload mode could be changed from the fast response mode to the on demand mode. Alternatively, in the event that the patient's condition improves to the extent that he is no longer considered to require active monitoring, the upload mode could be changed from the fast response mode to the very-long-term ECG mode.

FIG. 9 is a flow chart showing an algorithm, indicated generally by the reference numeral 80, showing an example of how the data upload period may be set. The algorithm 80 is provided by way of example only; many alternatives could be provided.

The algorithm starts at step 82, where the fast-rate upload mode is set as a default upload mode. Next, at step 84, it is determined whether any input (e.g. an input from the patient, an input from a doctor, or an input from the ECG interpreter 44) requires that the upload mode be changed to the on-demand mode. This may be because a serious potential health problem has been identified, or because the patient is about to have a consultation with the doctor. If so, the algorithm terminates at step 88, where the upload mode is changed to the on-demand mode; otherwise, the algorithm moves to step 85.

At step 85, it is determined whether any of the inputs has requested the long-term upload mode. If so, the algorithm moves to step 86; otherwise the algorithm terminates at step 90, where the default fast-rate mode is maintained.

At step 86, it is determined whether any of the inputs excludes the use of the long-term mode. For example, a doctor may exclude the use of the long-term mode where this might be inappropriate for the medical needs of a particular patient. If the use of the long-term mode has been excluded, the algorithm terminates at step 90, where the default fast-rate mode is maintained. If the use of the long-term mode has not been excluded, the algorithm terminates at step 92, where the long-term upload mode is used.

The system 1 provides a solution for both individuals and doctors, built upon low-cost ECG monitoring devices that are connected to the network via the mobile phone of the user and a Cloud based server architecture. Users have full mobility and heart rhythms are continually monitored with near “real time” feedback from an analytical engine being provided, if required. The solution supports continual recording, storage and processing of information for doctors. It automatically alerts the patient, first responders, doctors or caregivers of any major rhythm event.

Two exemplary use cases of the system 1 are described below.

The first use case is intended largely for use by doctors. ECG data is recorded by the system and the doctor can access the recorded data using the GUI 50 described above. In addition, the ECG interpreter 44 can alert the doctor in the event that potential problems (such as arrhythmia events) are detected.

The second use case is intended largely for use by individuals. The system 1 supports self-monitoring by the user (preventive care). This is facilitated by the ECG interpreter 44 running autonomously on the server 6. The server 6 notifies the user instantly if anomalies exceed a certain threshold and the user should visit the doctor. In case of danger to life the system 1 may also alert the emergency services and other caregivers (e.g. relatives or neighbors) nominated by the user. The user may provide his doctor access to his data.

As described above, the invention provides a simple low-cost ECG monitoring device connected to a server (typically cloud based) via a mobile network with a mobile phone acting as a gateway.

The remote software can analyse the data. Raw data, and analysed results, are stored in bulk remote from the sensor (e.g. in the cloud). The doctor has access to this data without requiring the patient to be present (and has access to data generated after the patient's last visit to the doctor).

The basic system architecture involves a sensor device, a mobile phone and a server. The sensor device is typically an “off-the-shelf” device, such as a digital plaster. The sensor communicates with a paired mobile phone in a very simple and well-established manner. The mobile phone has the relevant software installed. Data is received from the sensor and sent to the server; data buffering may be required (e.g. if connection to the server is lost). A data display (to the user) may be provided, but this is not essential. User notification (e.g. of alerts) may be provided. The server may require secure login and may have the bulk data storage and the main data processing capability of the system. The server typically provides the ECG interpretation, performs data plotting and issues alerts (if such a feature is provided by the system). The server may need to interface with multiple users (e.g. the patient, doctors, paramedics, relatives, emergency contacts).

Advantages of the invention include the following. Each part of the system can be optimized. The sensor can be as simple as possible (just provides data—no need for data processing); thus the sensor can be cheap and battery usage minimized. The communication system is optimized by allowing mobile phone operators to do all the work (e.g. redundancy by providing multiple communication methods). The storage in the cloud is cheap. The centralized software (rather than providing software to the phones) is cheaper, simpler and easier to update. The system enables long observations times that provide a clear medical advantage. The system is universal and scalable. The system is also flexible, allowing new applications/modified applications to be provided (e.g. by others) as required. Doctors have access to bulk data stored at the server regardless of whether the patient is present. Paramedics can also potentially access bulk data (e.g. via a similar GUI to that available to a doctor).

The main benefit for the individual is higher quality of life, a patient who is post operative or has post event condition (e.g. heart attack) is able to experience a quick, easy and safe reintegration into their home environment. A patient with the concern of a heart related disease can continue their private and professional routine as a result of being able to monitor their situation. Since the patient can stay at home, the so-called “white coat syndrome” is eliminated and occupational rehabilitation costs will be reduced.

There are benefits for the doctor as well. ECG monitoring costs can be significantly reduced through low-cost devices and simpler handling. Longer observation time supports a high quality of diagnosis. Cloud based computing with secure web access keeps infrastructure costs low.

The embodiments of the invention described above are illustrative rather than restrictive. It will be apparent to those skilled in the art that the above devices and methods may incorporate a number of modifications without departing from the general scope of the invention. It is intended to include all such modifications within the scope of the invention insofar as they fall within the scope of the appended claims.

1. A mobile communication device; comprising:
a first input configured to receive electrocardiography data of a user of the mobile communication device; and
a first output configured to provide said electrocardiography data to a server via a mobile communications link,
wherein said first output is configured to periodically provide said electrocardiography data to the server via the mobile communications link, and
wherein a time period between successive provisions of electrocardiography data to said server is variable.

2. A mobile communication device as claimed in claim 1, further comprising a second input configured to receive an indication from the server of a desired period between successive provisions of electrocardiography data to said server.

3. A mobile communication device as claimed in claim 1, further comprising a third input configured to receive an indication from the user of a desired period between successive provisions of electrocardiography data to said server.

4. A mobile communication device as claimed in claim 1, wherein, in a first mode, the time period between successive provisions of electrocardiography data to said server is equal to or greater than one day.

5. A mobile communication device as claimed in claim 1, wherein, in a second mode, the time period between successive provisions of electrocardiography data to said server is less than one hour.

6. A mobile communication device as claimed in claim 1, wherein, in a third mode, the time period between successive provisions of electrocardiography data to said server is zero.

7. A mobile communication device as claimed in claim 1, wherein the time period between successive provisions of electrocardiography data to said server is at least partially dependent on a power level of the mobile communication device.

8. An apparatus, comprising:
a first input configured to receive electrocardiography data from a mobile communication device via a mobile communications link, wherein the electrocardiography data relates to a user of said mobile communication device; and
a first output configured to indicate to the mobile communication device a desired period between successive provisions of the electrocardiography data.

9. An apparatus as claimed in claim 8, further comprising a second input configured to indicate a desired period between successive provisions of the electrocardiography data.

10. A method, comprising:
receiving electrocardiography data of a user at a first input of a mobile communication device; and
periodically providing said electrocardiography data from the mobile communication device to a server via a mobile communications link, wherein a time period between successive provisions of electrocardiography data to said server is variable.

11. A method as claimed in claim 10, wherein the time period between successive provisions of electrocardiography data is at least partially set by the server.

12. A method as claimed in claim 10, wherein the time period between successive provisions of electrocardiography data is at least partially set by the user.

13. A method, comprising:
receiving electrocardiography data from a mobile communication device via a mobile communication link, wherein the electrocardiography data relates to a user of said mobile communication device; and
indicating to the mobile communication device a desired time period between successive provisions of electrocardiography.

14. A method as claimed in claim 13, further comprising receiving a desired period between successive provisions of the electrocardiography data.

15. A computer program product comprising computer readable executable code which, when run on a processor, controls said processor to perform a method comprising:
receiving electrocardiography data of a user at a first input of a mobile communication device; and
periodically providing said electrocardiography data from the mobile communication device to a server via a mobile communications link, wherein a time period between successive provisions of electrocardiography data to said server is variable.

16. A computer program product comprising computer readable executable code which, when run on a processor, controls said processor to perform a method comprising:
receiving electrocardiography data from a mobile communication device via a mobile communication link, wherein the electrocardiography data relates to a user of said mobile communication device; and
indicating to the mobile communication device a desired time period between successive provisions of electrocardiography.
